(19) United States
(12) Patent Application Publication
(10) Pub. No.: US 2014/0001775 A1
(43) Pub. Date: Jan. 2, 2014

(54) Clip on doorstop

(71) Applicant: Alan Mullenbach, Oswego, IL (US)

(72) Inventor: Alan Mullenbach, Oswego, IL (US)

(21) Appl. No.: 13/507,472

(22) Filed: Jul. 2, 2012

(51) Int. Cl. E05C 19/18

(52) U.S. Cl. CPC E05C 19/188
USPC 292/288

(57) ABSTRACT

Disclosed is a doorstop assembly which allows a doorstop to be conveniently installed or removed from left or right swinging doors of varying thicknesses. The assembly has a portable door clip which may be easily pulled off a left swing door, turned upside down, and then pushed into place onto a right swing door. The portable door clip can firmly embrace doors of varying thickness. A dual lock leg mounted to the front of the door clip can be stowed in an upward position regardless of which way the door clip is turned, and then lowered toward the floor surface when in use to stop the door from closing.

### FIELD OF THE INVENTION

The present invention relates to doorstops, and more particularly, to a Portable clip on doorstop assembly that mounts onto standard swing type doors.

### BACKGROUND OF THE INVENTION

Standard type mounted doorstops are known in the art. They are typically mounted to the surface of a door with various types of mounting hardware. When the door is opened, the doorstop leg is moved from an upward stowed position to a downward position where it engages the floor and holds the door in place as shown in U.S. Pat. No. 3,831,989. Due to their mounting hardware, they tend to be permanently affixed to one door and not portable enough to move to other doors that require a doorstop. If they are removed, they leave behind holes or other damage in the doors they were mounted to.

To address the problem of portability, doorstop assemblies such as shown in U.S. Pat. No. 2,709,615 , U.S. Pat. No. 5,542,725 , and U.S. Pat. No. 2,774,622 were made. These door stop assemblies are associated with several disadvantages. Clip style assemblies such as U.S. Pat. No. 2,709,615 had the advantage of a simple design, but did not take into account varying door thickness. The design in U.S. Pat. No. 2,774,622 and U.S. Pat. No.5,542,725 accommodate varying door thickness, however they contain a multitude of moving parts which allow for a higher probability of mechanical failure. An overabundance of moving parts also increases the difficulty of installation and removal of the assembly.

None of these prior art devices disclose the use of a clip on doorstop assembly which accommodates for varying door thickness and allows for easy removal and installation onto left or right swinging doors.

### SUMMARY OF THE INVENTION

The present invention is an improved doorstop assembly which allows the doorstop to be mounted onto a left or right swinging door of varying thickness. A doorstop assembly comprises a portable door clip formed from a spring steel or other suitable flexible material. The portable door clip comprises a first front side for abutting a planar side of a door, a second side for abutting the jamb side of a door, and a third back side for abutting the opposite planar side of a door. The first front side is attached to the second side at a right or acute angle and the second side is attached to the third backside at a substantially acute angle. The design of the portable door clip provides a means of affixing the entire portable doorstop assembly to a door of varying thickness by employing a spring tension. A dual lock leg is pivotally mounted on the face of the first front side of the portable door clip such that the pivotal mounting allows the dual lock leg to move from an essentially upward vertical stowed position to an essentially downward floor engaging position. The downward floor engaging position of the dual lock leg is intended to hold the door open. The dual lock leg is provided a support means for a dual lock capability such that it may be locked in an upward vertical stowed position even though the entire doorstop assembly may be rotated upside down prior to installation onto a door.

One object of the invention is to provide a doorstop that is easily secured to a door, and when needed, moved to a different door that may swing in the opposite direction or have a different thickness. The portable door clip is shaped to embrace different door thicknesses and is simply pushed into place onto the side of the door where it is held by spring tension and ready for operation. In order to remove the doorstop assembly from one door and install it onto a door which opens in the opposite direction the doorstop assembly need only to be turned upside down relative to the first door and then pushed into place onto the second door. The dual lock leg may be functionally stowed when rotated in an upward position, regardless of the reorientation of the entire doorstop assembly, by employing multiple support means such as a mechanical, Velcro, or magnets.

A further object of the invention is to provide a portable doorstop that does not damage the surface on which it is mounted. The portable door clip may employ a coating of Teflon, double sided tape, rubber, or other suitable materials which provide a greater protection against chaffing damage between the portable door clip and the door to which it is affixed.

### BRIEF DESCRIPTION OF THE DRAWINGS

The accompanying drawings incorporated in the specification illustrate several aspects of the invention, and together with the description serve to explain the principles of the invention.

FIG. 1 is a perspective view from the front showing the doorstop assembly in the lowered floor engaging position;

FIG. 2a is a side view of the portable door clip with the dual lock leg and its support spurs, positioned between lowered floor engagement and vertical stowed position;

FIG. 2b is a side view of the portable door clip, dual lock leg, and support spurs in the vertical stowed position;

FIG. 2c is a side view of the portable door clip, dual lock leg, and its support spurs in the lowered floor engaged position;

FIG. 3a is a perspective view showing the doorstop assembly mounted onto a left and right standard swing type door;

FIG. 3b is a top down view of the doorstop assembly prior to mounting onto a standard swing type door; and

FIG. 3c is a top down view of the doorstop assembly after it is installed onto a standard swing type door.

FIG. 4 is a perspective view from the front showing an alternative embodiment wherein the portable door clip and the dual lock leg comprised support magnets; and

FIG. 5 is a side view showing the support magnets holding the dual lock leg in a vertical stowed position.

### DETAILED DESCRIPTION OF THE PREFERRED EMBODIMENT

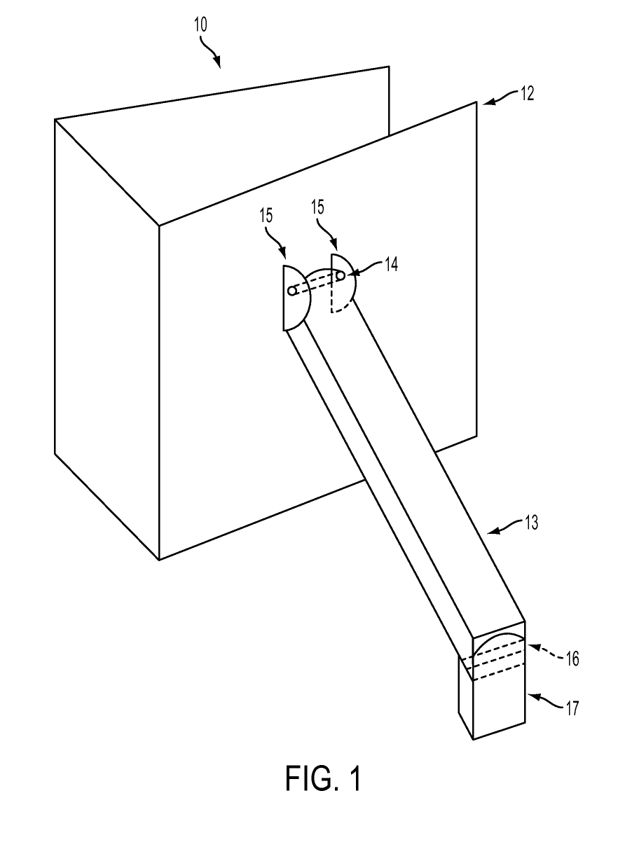

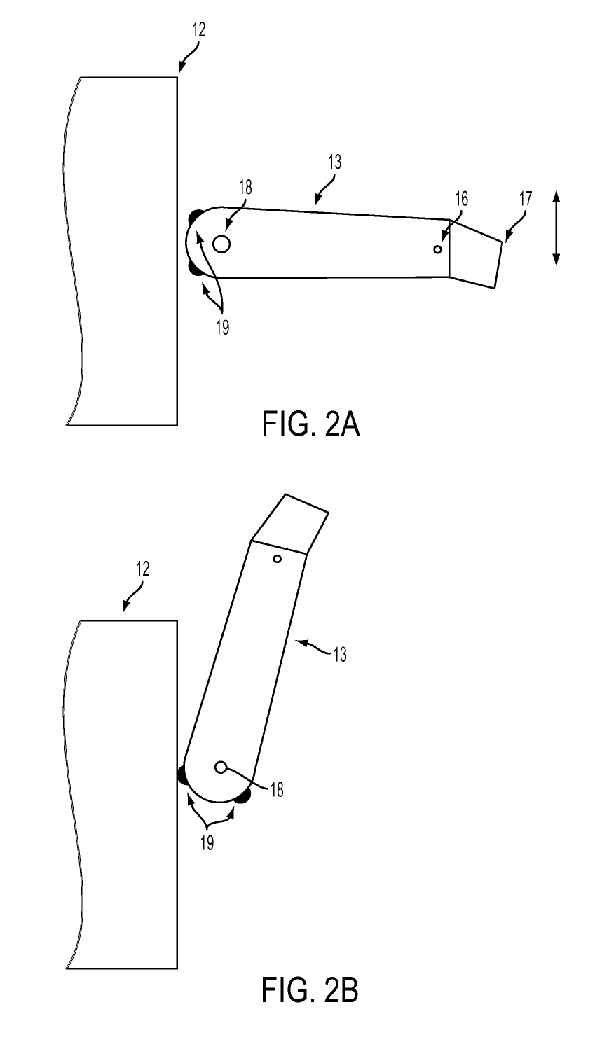

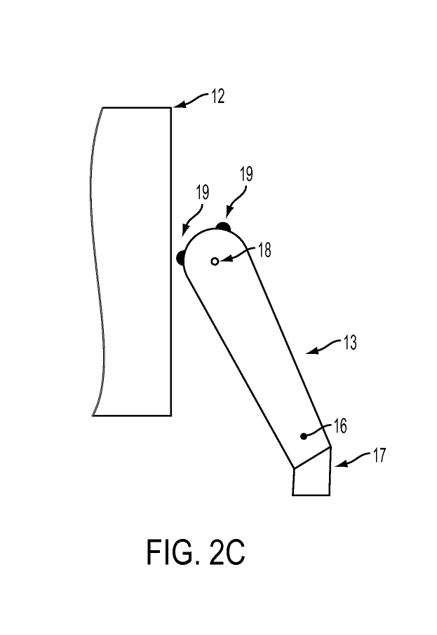

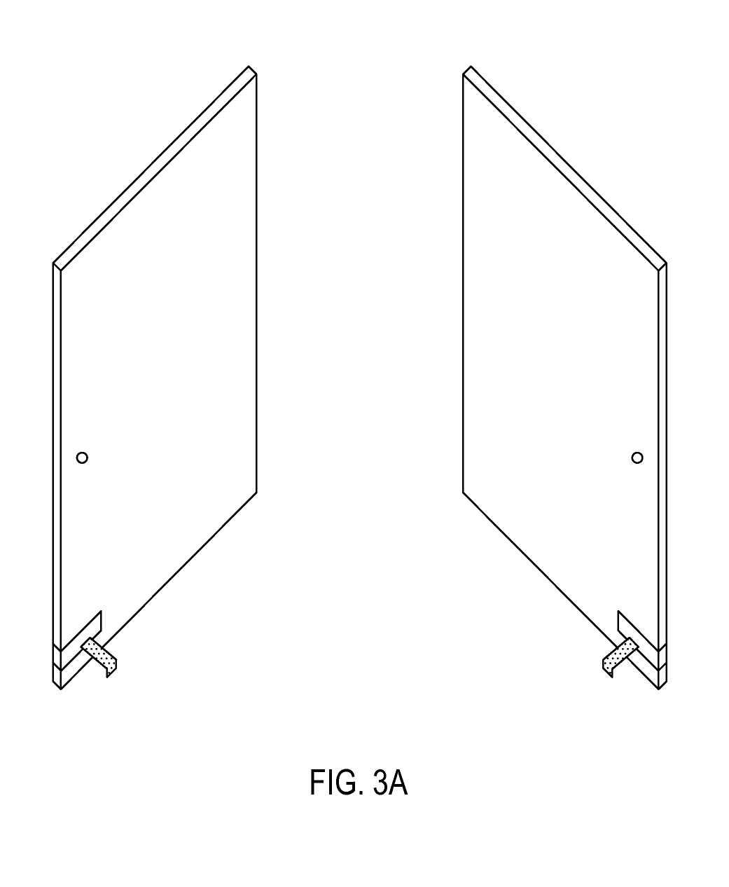

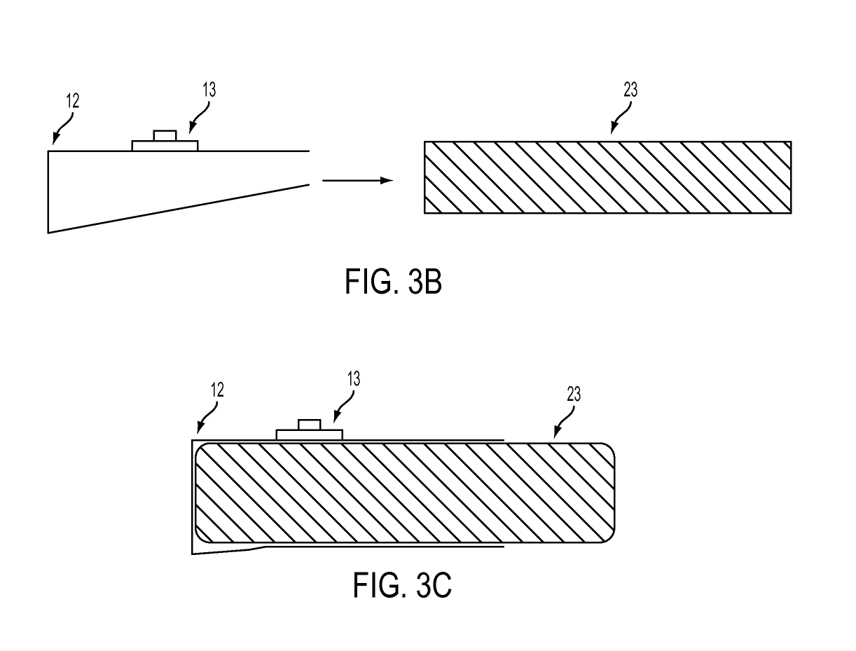

Referring to FIGS. 1, 4 and 5 a door stop assembly 10 employs a portable door clip 12. The portable door clip 12 comprises sequence of three sides which may be obtained by folding a single piece of flat planar material such as spring steel or other suitable flexible material. One of ordinary skill in the art will understand there are a number of alternative ways to either fold or attach the three sides such as welding, or various adjoining hardware. As displayed in FIGS. 3b and 3c, the three sides of the portable door clip 12 comprise a first front side which is intended to abut the planar side of a swing door 23, a second side positioned at a right or acute angle to the first side which is intended to abut the jamb side of the door 23, and a third back side positioned at a substantially acute angle to the second side which is intended to abut the opposite planar side of the door 23 as the first front side. Because of its flexibility, angle pattern, and the surface area of its corresponding sides, the portable door clip 12 is designed to embrace a standard swing type door of varying thickness by simply pushing it into place onto the door 23. Alternatively, additional components such as a sheet of flat rubber, or various coatings such as rubber or adhesive may be affixed to the inside concave portion of the portable door clip 12 to enhance embracing firmness, and to prevent damage to the door 23 mounting surface. Referring to FIG. 3a the doorstop assembly 10 is reversible such that it may be removed from a right swing door 21, reoriented upside down, and then reinstalled onto a left swing door 22. Pivotally attached to the first front side of the portable door clip 12 is a dual lock leg 13. Referring to FIG. 1, which depicts the preferred embodiment, the dual lock leg 13 is pivotally attached to the face of the portable door clip 12 using pivots 14 capable of rotating around an axis, shaft, hinges or pins. The pivots 14 allow the dual lock leg 13 to be raised toward a vertical stowed position, or to be operationally rotated lower toward a position which enables the dual lock leg 13 to engage with a floor surface thus stopping a door from swinging. When the doorstop assembly 10 is not installed onto a door, the pivots 14 allow the dual lock leg 13 to rotate from a full upward position to a full downward position with both of these positions being essentially parallel to the portable door clip 12. It is essential to the proper operation of the doorstop assembly 10 that the dual lock leg 13 has a means of support to lock in an upward vertical stowed position within both possible operational orientations of the portable door clip 12. Continuing in this embodiment shown in side view FIGS. 2a, 2b, and 2c the dual lock leg 13 comprises a conventional pivot hole 18 and a pair of spurs 19 either attached to or as an integral part of the dual lock leg 13. In contrast with prior art which typically employs the use of only a single spur, the pair of spurs 19 creates a means of support for a dual lock capability. Depending on the appropriate orientation of the portable door clip 12, whichever of these spurs 19 is located in the upward most position will engage with the flat surface face of the portable door clip 12, or alternatively will engage with an additionally added flat surface component when the dual lock leg 13 is rotated into an upward vertical stowed position. The engagement of the upper spur 19 with the flat surface will cause sufficient friction to maintain the dual lock leg 13 in an upward stowed position. The dual lock leg 13 may comprise a thoroughly solid element, or alternatively an additional foot member 17 may be pivotally attached using a shaft, hinge, or pin 16 to accommodate the variable angles of floor engagement. Alternatively, the foot member 17 may comprise a rubberized tip or coating to facilitate greater friction between itself and the floor surface with which it interacts.

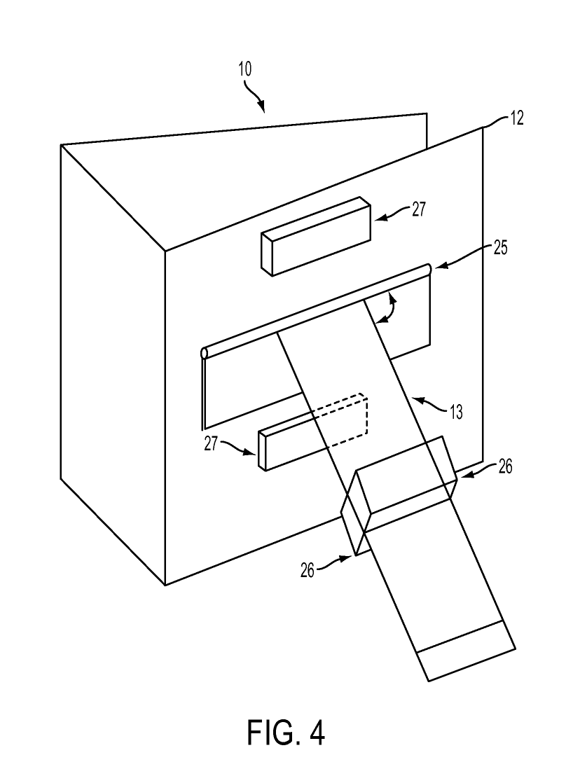

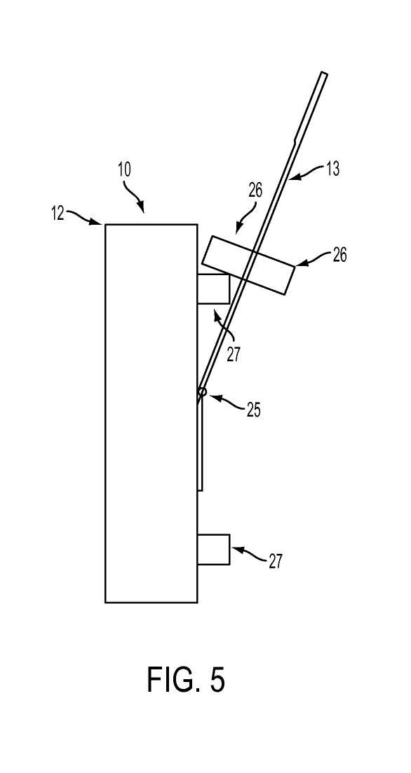

In another embodiment shown in FIG. 4 and FIG. 5 the doorstop assembly 10 comprises a portable door clip 12 with a pivotally attached dual lock leg 13, and a plurality of support magnets 26 and 27. This embodiment employs the use of magnets to achieve dual lock capability of the dual lock leg 13. Support magnets 27 are affixed to the face of the portable door clip 12, and additionally, support magnets 26 are affixed to the dual lock leg 13 by employing a variety of mounting hardware, glue, Velcro, or by magnetic attraction alone. Alternatively, support magnets may be affixed to the portable door clip 12, or to the dual lock leg 13 alone. The pivot 25 is attached to the face of the portable door clip 12 and allows the dual lock leg 13 an operational rotation range from an upward stowed position to a downward floor engaging position. The placement of the support magnets 26 and 27 enable the dual lock leg 13 to become locked in the vertical upward stowed position regardless of the orientation of the portable door clip 12 when the doorstop assembly 10 is not in use.

1. A doorstop assembly comprising;
a portable door clip comprising a first front side, a second adjacent side, and a third back side;
wherein said first front side is attached to said second adjacent side at a right or acute angle and said second adjacent side is attached to said third back side at a substantially acute angle;
a dual lock leg pivotally mounted on said front side of the portable door clip wherein the pivotal mounting allows the dual lock leg to rotate from an essentially upward vertical position to an essentially downward vertical position;
a plurality of dual lock leg supports to maintain said dual lock leg in either vertical position; and
one or more attaching components or coatings affixed to the concave portion of said portable door clip for attaching to a first mounting surface.

2. The doorstop assembly of claim 1 wherein the portable door clip is flexible and exerts sufficient spring tension to embrace different potential thicknesses of said first mounting surface.

3. The doorstop assembly of claim 1 wherein the dual lock leg supports comprise: a plurality of supports at the proximal end of said dual lock leg either attached to, or as an integral part of said dual lock leg element; and
A flat surface as provided by the face of said portable door clip or by an additionally added flat surface parallel to said portable door clip face wherein said support spurs interact with and temporarily lock onto the flat surface when said dual lock leg is rotated toward a upward vertical position substantially parallel to said portable door clip.

4. The doorstop assembly of claim 3 wherein the dual lock leg comprises: a foot member pivotally attached to the distal end of said dual lock leg which adapts for irregular angles between said dual lock leg and the floor surface to which transverse pressure is applied.

5. A doorstop assembly comprising: a portable door clip comprising a first front side folded or attached to a second adjacent side at a right or acute angle, and a third back side which is folded or attached at a substantially acute angle to said second side;
One or more attaching components or coatings affixed to the concave portion of said portable door clip for attaching to a first mounting surface;
a dual lock leg pivotally mounted on said front side of the portable door clip wherein the pivotal mounting allows the said dual lock leg to move from an essentially upward vertical position to an essentially downward vertical position; and
a plurality of attaching components to maintain said dual lock leg in either vertical position.

6. The doorstop assembly of claim 5 wherein the portable door clip is flexible and exerts sufficient spring tension to embrace different potential thicknesses of said first mounting surface.

7. The doorstop assembly of claim 6 wherein said portable door clip further comprises;
a plurality of attaching components affixed to said front side of the portable door clip for attaching to said dual lock leg when said dual lock leg is moved into either vertical position.

8. The doorstop assembly of claim 5 wherein said dual lock leg further comprises;
a plurality of affixed attaching components positioned at a substantial distance from the proximal end of said dual lock leg for attaching to said front side of the portable door clip when said dual lock leg is moved into either vertical position.
